(19) United States
(12) Patent Application Publication
(10) Pub. No.: US 2026/0004156 A1
(43) Pub. Date: Jan. 1, 2026

(54) SYSTEM AND METHOD FOR QUESTION-RESPONSE GENERATION USING GRAPH NEURAL NETWORKS CONSTRAINT UNDER BEAM SEARCH

(71) Applicant: Dell Products L.P., Round Rock, TX (US)

(72) Inventors: Srishti Gupta, Bangalore (IN); Saurabh Jha, Austin, TX (US)

(21) Appl. No.: 18/759,938

(22) Filed: Jun. 30, 2024

(51) Int. Cl. G06N 5/02; G06N 3/092

(52) U.S. Cl. CPC G06N 5/02; G06N 3/092

(57) ABSTRACT

A method for updating a question-answer mechanism includes obtaining, by a data system implementing the question-response mechanism, an input query, in response to the input query: generating a token sequence associated with the input query by applying a beam search algorithm on generated bound knowledge graphs, applying the input query to a large language model (LLM) of the question-response mechanism to obtain first outputs, applying the generated token sequence to a graph neural network (GNN) to obtain second outputs, applying fusion layers on the first outputs and the second outputs to generate a response associated with the input query and generated token sequence, and performing a remediation using the generated response, wherein the remediation comprises updating the LLM and the GNN based on the generated response.

### BACKGROUND

Customer grievance redressal refers to the process of addressing and resolving complaints and concerns raised by customers regarding a product, service, or experience. It is an important aspect of customer service and plays a crucial role in building and maintaining a positive reputation for a business. Effective customer grievance redressal requires a customer-focused approach, open communication, and a willingness to address customer concerns promptly and effectively. Building a solution for the customers where they can make queries about their products, orders, cash transactions, balance inquiries, transaction history, and account statements and receive appropriate response will fasten the redressal process.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a data system in accordance with one or more embodiments of the invention.

FIG. 3.1 shows a flowchart of a method of generating bound knowledge graphs in accordance with one or more embodiments of the invention.

FIG. 3.2 shows a flowchart of a method of implementing a question-answer mechanism using generated bound knowledge graphs in accordance with one or more embodiments of the invention.

FIG. 4 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or preceded) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments disclosed herein include obtaining data sources such as tables and documents, performing graph creation, obtaining user query, applying graph refinement, training a model that includes a language model and graph neural networks, and generating user responses. The proposed solution may be split into 3 pipelines: bounded knowledge graph construction using encoder decoder architecture, interoperability of knowledge graphs with graph neural networks (GNNs) using structural and situational constraint, and discrete prompt generation using reinforcement learning to prevent intrinsic artificial intelligence (AI) hallucinations.

In one or more embodiments, pre-trained language models are leveraged to carry out question-answering mechanisms which do not perform very well even after fine tuning on domain specific datasets. In one or more embodiments, the intelligence available from language models are exploited, coupled with knowledge graphs to provide more relevant and structured responses. Specifically, embodiments of the invention implement an architecture where the multiple layers of language models and knowledge graphs are infused together for improved response generation. Embodiments of the invention include using input queries written in a natural language as contextual input to language models and a Graph Neural Network (GNN) reasoned over the knowledge graph. After each layer of the language model and GNN, an interactive scheme is designed to bidirectionally transfer the information from each modality to the other through specially initialized interaction representations (i.e., interaction token for the language model; interaction node for the GNN). In such a way, all the tokens in the language context receive information from the knowledge graphs through the interaction token and the knowledge graphs indirectly interact with the tokens through the interaction node. By such a deep integration across all layers, embodiments disclosed herein ensure joint reasoning over both the language context and the knowledge graphs under a unified framework agnostic to the specific language model or graph neural network, so that both modalities may be contextualized by the other. Such approach captures the structural aspect of the input data.

The following describes various embodiments of the invention.

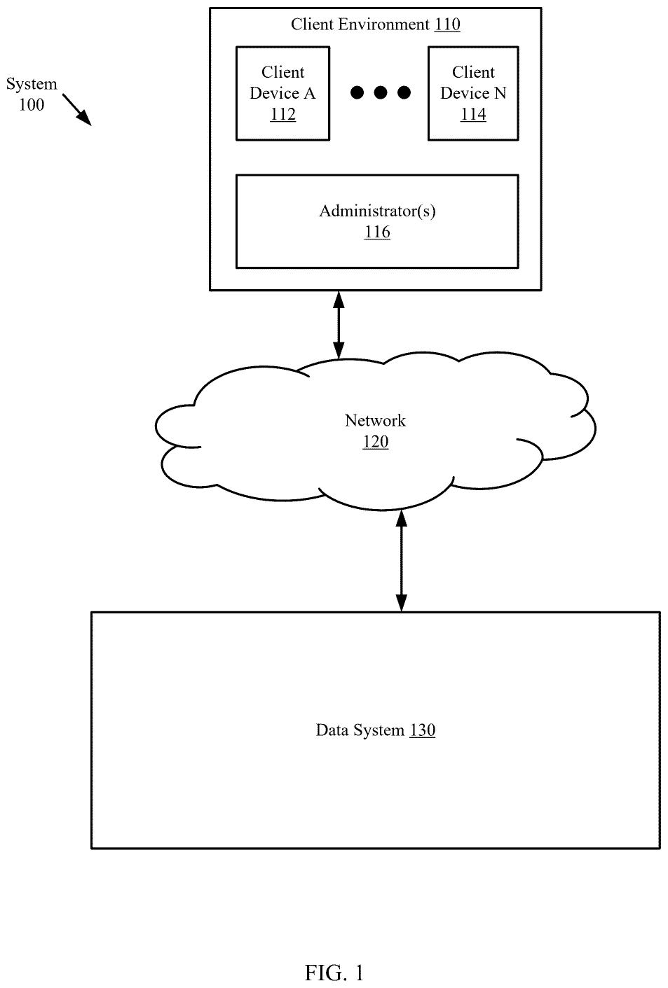

FIG. 1 shows a system in accordance with one or more embodiments of the invention. The system (100) includes a client environment (110) that includes any number of client devices (112, 114) and any number of administrators (116), a network (120), and a data system (130). The system (100) may include additional, fewer, and/or different components without departing from scope of the invention. Each component may be operably connected to any of the other component via any combination of wired and/or wireless connections. Each component illustrated in FIG. 1 is discussed below.

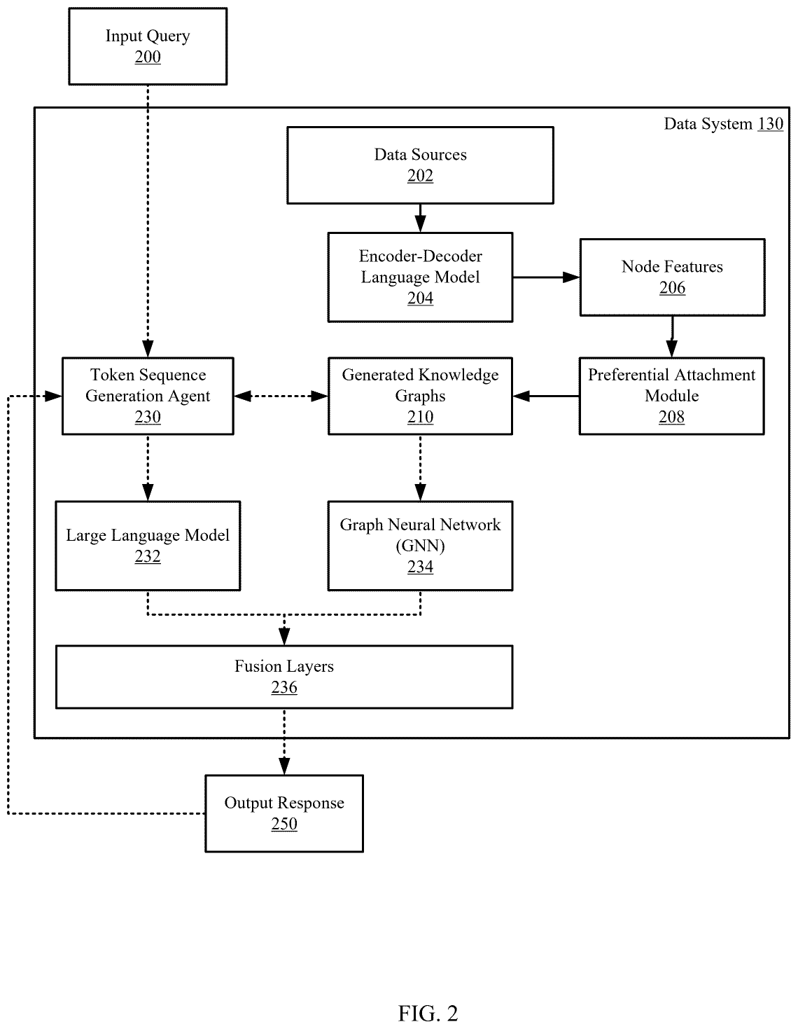

In one or more embodiments, the clients (112, 114) are each operated by users. The users may issue requests for text to the data system (130) that is associated with one or more data sources (discussed in FIG. 2). The requests may be input queries issued to a large language model (discussed in FIG. 2) of the data system (130). The data sources may be, for example, tabular data structures, previous conversations between the users and the administrators (116) of the client environment (110), and/or any other data structures without departing from the invention.

In one or more embodiments of the invention, the data system (130) may provide computer-implemented services to users of the client devices (112, 114). The computer-implemented services may include processing input text using a large language model (LLM) and a graph neural network (GNN) to obtain output responses. The input text may be obtained from the client devices (112, 114). The output response may be based on training performed on the LLM and GNN (both discussed in FIG. 2). The data system (130) may provide other computer-implemented services without departing from the invention. For additional details regarding the data system (130), refer to FIG. 2.

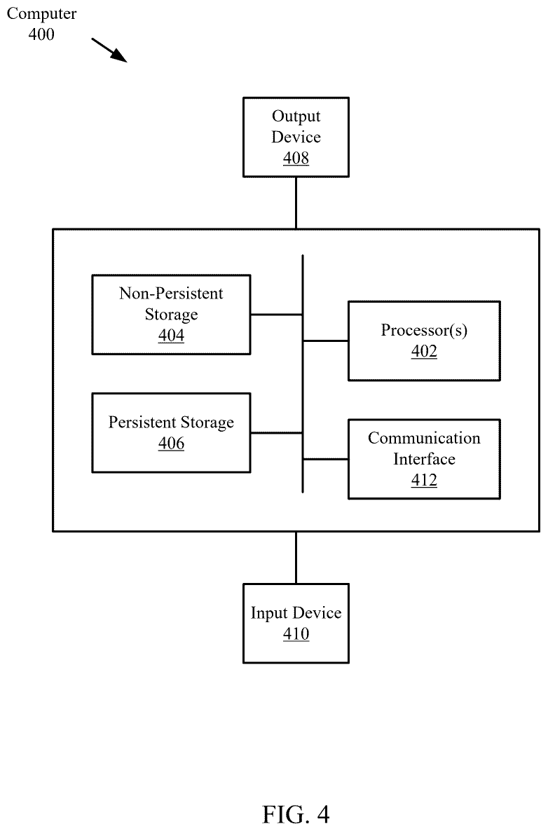

In one or more embodiments of the invention, the data system (130) (and/or any components illustrated within) may be implemented as a computing device (e.g., 400, FIG. 4). A computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the data system (130) (and/or any components illustrated within) described throughout this present disclosure.

Alternatively, in one or more embodiments of the invention, the data system (130) (and/or any components illustrated within) may be implemented as logical devices. A logical device may utilize the computing resources of any number of computing devices to provide the functionality of the data system (130) (and/or any components illustrated within) described throughout this present disclosure.

In one or more embodiments of the invention, the above-mentioned system (100) components may operatively connect to one another through a network (120) (e.g., a local area network (LAN), a wide area network (WAN), a mobile network, a wireless LAN (WLAN), etc.). In one or more embodiments, the network (120) may be implemented using any combination of wired and/or wireless connections. The network (120) may encompass various interconnected, network-enabled subcomponents (not shown) (e.g., switches, routers, gateways, etc.) that may facilitate communications between the above-mentioned system (100) components.

In one or more embodiments of the invention, the network-enabled subcomponents may be capable of: (i) performing one or more communication schemes (e.g., Internet protocol communications, Ethernet communications, communications via any security protocols, etc.); (ii) being configured by the computing devices in the network (120); and (iii) limiting communication(s) on a granular level (e.g., on a per-port level, on a per-sending device level, etc.).

FIG. 2 shows a diagram of a data system. The data system (130) of FIG. 2 may be an embodiment of the data system of FIG. 1. The data system (130) includes functionality for generating knowledge graphs (210) and using the knowledge graphs (210) for output response (250) generation based on an obtained input query (200). To generate the knowledge graphs (210), the data system (130) uses data sources (202) such as tabular data structures or previous conversations between users and administrators of a client environment (110, FIG. 1). For example, the data sources may be a table of cash-to-order use case in which transaction information is tracked using the table. The table may include any number of columns such as, for example, a business unit identifier, a customer number, an investment sum value, an investment count, and/or any other columns without departing from the invention. As a second example, the data source (202) may be a conversation between a user having an issue with an order and/or queries about a previous transaction. The conversation may track a timestamp of each message, which entity is associated with each message, and/or any other metadata without departing from the invention.

The data sources (202) may be applied to a pre-trained encoder-decoder language model (204) to obtain a set of nodes. The node generation may be formulated as a sequence-to-sequence problem, where the system is fine-tuned to translate textual input to a sequence of nodes, separated with special tokens, i.e., <PAD>NODE1<NODE_SEP>NODE2<NODE_SEP>NODE3</S>, where NODE1 represents one or more words. Further, the data system uses learned node queries to obtain node features (206) and estimate a permutation to align with a target node order. The decoder receives a set of learnable node queries, represented as an embedding matrix. The output of the decoder can now be directly read-off as N d-dimensional node features Fn∈Ðd×N and passed to a prediction head (GRU) to be decoded into node logits, Ln∈ÐS×V×N, where S is the generated node sequence length and V is the vocabulary size.

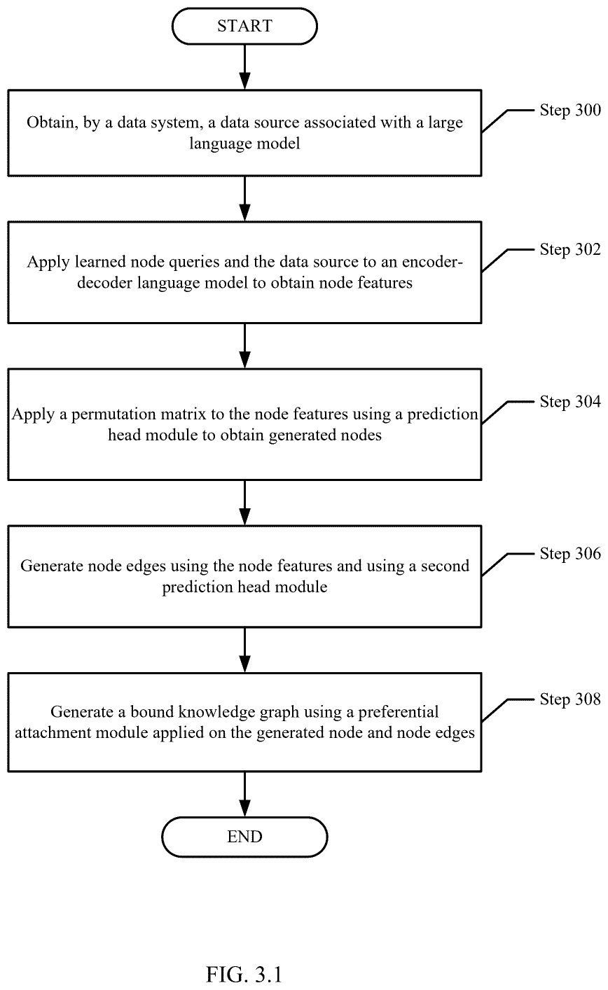

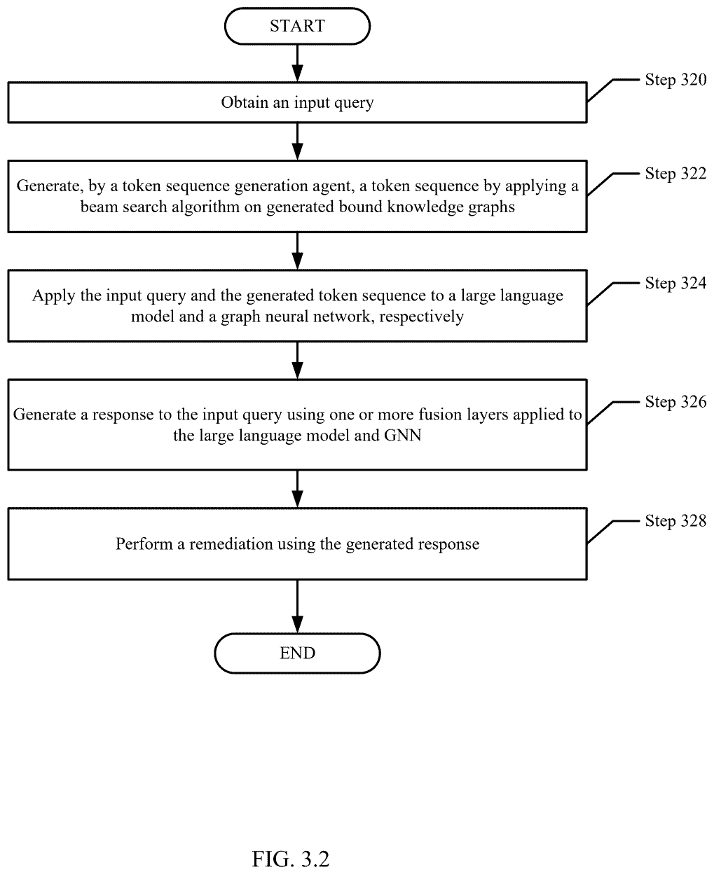

Given a pair of node features (206), a prediction head decides the existence (or not) of an edge between their respective nodes using a GRU prediction head module to generate edges as a sequence of tokens. To determine whether to maintain an edge between two nodes using the node features (206), a preferential attachment module (208) may use a simple difference between the feature vectors: F′n (:,i)-F′n (:,j) for the case when the node i is a parent of node j. The obtained result is a generated knowledge graph (210). One or more generated knowledge graphs (210) may be generated for each of the data sources (202). For additional details regarding the generation of the generated knowledge graphs (210), refer to FIG. 3.1.

In one or more embodiments, the generated knowledge graphs (210) may be used to generate an output response (250) in response to an input query (200). The input query (200) may be obtained from a client device (112, 114) discussed above. The input query (200) may be, for example, a question in a natural language (e.g., English, Spanish, Mandarin) that requests information about one of the data sources (202). The input query (200) may be obtained by a token sequence generation agent (230) that applies a beam search on the input query based on generated nodes of the input query (200) to obtain a token sequence. The token sequence may be generated using the beam search algorithm applied to the generated knowledge graphs (210). The token sequence may be a textual representation of an input to the large language model (232) that is pre-trained to obtain a textual input and output a textual response based on pre-set responses and using the data sources (202). In one or more embodiments, the LLM (232) may be used in tandem with a one or more fusion layers (236) that obtains the generated knowledge graphs (210) and applies them to the Graph Neutral Network (GNN (234)) to obtain secondary outputs that are used with secondary outputs of the Large Language Model (LLM (232)) to generate additional outputs. The additional outputs are applied to any number of the fusion layers (236) to obtain the output response (250). The output response may be used for reinforcement learning by the token sequence generation agent (230) to improve or otherwise update the LLM (232) and/or the GNN (234) for future processing of input queries. For additional details regarding the processing of the input queries (200), refer to FIG. 3.2.

FIG. 3.1 shows a flowchart of a method of generating bound knowledge graphs in accordance with one or more embodiments of the invention. The method shown in FIG. 3.1 may be performed by, for example, a data system (130, FIG. 1). Other components of the system in FIG. 1 or 2 may perform all, or a portion, of the method of FIG. 3.1 without departing from the invention.

While FIG. 3.1 is illustrated as a series of steps, any of the steps may be omitted, performed in a different order, additional steps may be included, and/or any or all of the steps may be performed in a parallel and/or partially overlapping manner without departing from the invention.

Turning to FIG. 3.1, in step 300, a data source associated with a large language model is obtained. As discussed above, the data source may be a tabular data structure, a stored conversation between a user of a client environment and an administrator of the client environment regarding one or more orders, and/or any other data structures without departing from the invention.

In step 302, learned node queries and the data source are applied to an encoder-decoder language model to obtain node features. In one or more embodiments, the learned node queries are pre-defined nodes previously used for LLM training and used for defining nodes. The learned node queries may be, for example, training data that specify node separation mechanisms of future nodes. The encoder-decoder language model may be trained using the learned node queries to separate the text in a data source using the node separation mechanisms. Each node may be, for example, a word of the data source, a corresponding column of a table of the data sources, a grouping of words, and/or other nodes without departing from the invention.

In one or more embodiments, the node features may be the output of the encoder-decoder language model. The output may be N d-dimensional node features defined as Fn∈Ðd×N and passed to a prediction head (GRU) to be decoded into node logits, Ln ∈ÐS×V×N, where S is the generated node sequence length and V is the vocabulary size.

In step 304, a permutation matrix is applied to the node features using a prediction head module to obtain generated nodes. To avoid the system to memorize the target node order and enable permutation-invariance, the logits and features are permuted as L′n(s)=Ln(s)P, F′n=FnP, for s=1 . . . , S and where P∈ÐN×N is a permutation matrix obtained using bipartite matching algorithm between the target and the greedy-decoded nodes. Embodiments of the invention include using cross-entropy loss as the matching cost function. The permuted node features F′n become target-aligned and can be used in the edge generation stage.

In step 306, node edges are generated using the node features and using a second prediction head module. In one or more embodiments, the second head prediction module may be a

In step 308, bound knowledge graphs (also referred to as generated knowledge graphs) are generated using a preferential attachment module applied on the generated nodes and node edges. The boundary for graph generation at an input text level is defined; it helps in reducing the noise which crops in while dealing with large graphs with huge set of nodes and edges. This is accomplished using light variations to a Barabasi-Albert preferential attachment module. For a given start and target node, the edges in between the picked nodes have degree higher than the average degree. Given the graph at time t, the edges incident to the vertex with label t+1 are attached to older vertices that are chosen according to a probability distribution that is an affine function of the degrees of the older vertices. This way, vertices that already have a high degree are more likely to attract edges of later vertices. Let a graph sequence be denoted as PAnδ,C. At the (n+1)th stage, a new node named vn+1 is added along with C edges each of which has vn+1 as one of its vertices, and the other vertex is selected from Vn:={v1, v2, . . . , vn} with probability proportional to the degree of the vertex (shifted by a parameter δ) in PAnδ,C.

$$For 1 \leq i \leq n : pi , n + 1 := P [ v i ↔ v n + 1 \vert PAn δ , C ] = D i ( n ) + δ / ( 2 C + δ ) n$$

$$Here Di ( n ) := degree of vi in PAn δ , C$$

The result of applying the above edge generation and preferential attachment module results in bound generated knowledge graphs. The generated bound knowledge graphs may be used for output response generation.

FIG. 3.2 shows a flowchart of a method of implementing a question-answer mechanism using generated bound knowledge graphs in accordance with one or more embodiments of the invention. The method shown in FIG. 2.2 may be performed by, for example, the data system (130, FIG. 1). Other components of the system in FIG. 1 may perform all, or a portion, of the method of FIG. 3.2 without departing from the invention.

While FIG. 3.2 is illustrated as a series of steps, any of the steps may be omitted, performed in a different order, additional steps may be included, and/or any or all of the steps may be performed in a parallel and/or partially overlapping manner without departing from the invention.

Turning to FIG. 3.2, in step 320, an input query is obtained. In one or more embodiments, the input query is a text message written in a natural language to a user.

In step 322, a token sequence is generated by applying a beam search algorithm on the generated bound graphs. In one or more embodiments, a beam search algorithm is an algorithm for determining an ideal sequence of nodes based on pre-defined knowledge graphs (e.g., the knowledge graphs generated in FIG. 3.1), based on strength of relation of connected edges between the nodes, and/or other parameters without departing from the invention. The beam search algorithm may include determining a start node (e.g., a first token of the token sequence), a target node (e.g., the last token of the token sequence), and determining a highest-rated edge for each subsequent token that would connect the start node to the target node. Each node connected by a highest-rated edge would be included in the token sequence.

In step 324, the input query is applied to a large language model (LLM), and the token sequence is applied to a graph neural network (GNN). In one or more embodiments, the applications of the input query and the token sequences to the LLM and GNN, respectively, are used to generate intermediate outputs.

In step 326, a response is generated by applying fusion layers to the intermediate outputs. The generated response may be a result of applying the intermediate outputs to multiple fusion layers that outputs a response that incorporates the LLM output and the GNN outputs.

In step 328, a remediation is performed on the LLM and GNN using the generated response. In one or more embodiments, the remediation includes updating the LLM and GNN using reinforcement learning. To improve the accuracy of the output response, the reinforcement learning includes automatic discrete prompt generation. Automatically finding the optimal prompt for each task, however, is challenging. A large black-box language model presents a highly complex environment that, given the prompt (i.e., actions), goes through a long series of complex transitions (e.g., reading the input and inferring the output) before computing the rewards. This makes the reward signals extremely unstable and hard to learn from. To overcome this difficulty, the bounded knowledge graphs generated in FIG. 3.1 are utilized for generating the discrete tokens for prompt generation. Reinforcement learning ensures that the optimized discrete prompts are generated after training with reward; an agent selects prompt tokens [z1 . . . , zT] one by one to maximize the reward R(yLM(z, x)). At time step t, the token sequence generation agent receives previous prompt tokens z<t and generates the next prompt token zt according to a policy π(zt|z<t). After the agent finishes the entire prompt z\hat{ }, it receives the task reward R(yLM(z\hat{ }, x)). Parameterizing the policy with θ, can be rewritten as—maxθ R(yLM(z\hat{ }, x)), z\hat{ }˜ΠTπθ(zt|z<t)

The reinforcement learning approach explores the prompt space more efficiently guided by the reward signals. The policy network also brings added flexibility, e.g., it can take other information such as the input x, leading to input-specific prompts.

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms. Embodiments disclosed herein include a solution for assisting customers and front-line representatives of a corporate entity in making queries about their products, orders, cash transactions, balance inquiries, transaction history, and account statements and receive appropriate response using large language models and graph neural networks infused with bounded knowledge graphs and optimized using beam search making customer redressal process smoother and faster, preventing AI hallucinations.

Thus, embodiments of the invention may address the problem of limited computing resources in a distributed system. The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for updating a question-response mechanism in a data system, the method comprising:
obtaining, by a data system implementing the question-response mechanism, an input query;
in response to the input query:
generating a token sequence associated with the input query by applying a beam search algorithm on generated bound knowledge graphs;
applying the input query to a large language model (LLM) of the question-response mechanism to obtain first outputs;
applying the generated token sequence to a graph neural network (GNN) to obtain second outputs;
applying fusion layers on the first outputs and the second outputs to generate a response associated with the input query and generated token sequence; and
performing a remediation using the generated response, wherein the remediation comprises updating the LLM and the GNN based on the generated response.

2. The method of claim 1, further comprising:
prior to obtaining the input query:
obtaining a data source associated with the LLM;
applying one or more learned node queries and the data source to an encoder-decoder language model to obtain node features;
applying a permutation matrix on the node features using a prediction head module to obtain generated nodes;
generating node edges using a second prediction head module; and
applying a preferential attachment module on the generated nodes and the generated node edges to generate a bound knowledge graph of the generated bound knowledge graphs.

3. The method of claim 2, wherein the beam search algorithm comprises determining a sequence of the generated nodes based on situational constraints and the node features.

4. The method of claim 2, wherein the data source is a tabular dataset associated with order-to-cash information.

5. The method of claim 4, wherein the input query comprises a question in a natural language asking for information corresponding to the tabular dataset, and wherein the generated response is in the natural language.

6. The method of claim 2, wherein the data source is a conversation between a user of a client environment via a client device and an administrator of the client environment.

7. The method of claim 1, wherein the generated response is based on a set of response templates associated with the LLM.

8. A non-transitory computer readable medium comprising computer readable program code, which when executed by a computer processor enables the computer processor to perform a method for updating a question-response mechanism in a data system, the method comprising:
obtaining, by a data system implementing the question-response mechanism, an input query;
in response to the input query:
generating a token sequence associated with the input query by applying a beam search algorithm on generated bound knowledge graphs;
applying the input query to a large language model (LLM) of the question-response mechanism to obtain first outputs;
applying the generated token sequence to a graph neural network (GNN) to obtain second outputs;
applying fusion layers on the first outputs and the second outputs to generate a response associated with the input query and generated token sequence; and
performing a remediation using the generated response, wherein the remediation comprises updating the LLM and the GNN based on the generated response.

9. The non-transitory computer readable medium of claim 8, further comprising:
prior to obtaining the input query:
obtaining a data source associated with the LLM;
applying one or more learned node queries and the data source to an encoder-decoder language model to obtain node features;
applying a permutation matrix on the node features using a prediction head module to obtain generated nodes;
generating node edges using a second prediction head module; and
applying a preferential attachment module on the generated nodes and the generated node edges to generate a bound knowledge graph of the generated bound knowledge graphs.

10. The non-transitory computer readable medium of claim 9, wherein the beam search algorithm comprises determining a sequence of the generated nodes based on situational constraints and the node features.

11. The non-transitory computer readable medium of claim 9, wherein the data source is a tabular dataset associated with order-to-cash information.

12. The non-transitory computer readable medium of claim 11, wherein the input query comprises question in a natural language asking for information corresponding to the tabular dataset, and wherein the generated response is in the natural language.

13. The non-transitory computer readable medium of claim 9, wherein the data source is a conversation between a user of a client environment via a client device and an administrator of the client environment.

14. The non-transitory computer readable medium of claim 13, wherein the generated response is based on a set of response templates associated with the LLM.

15. A system, comprising:
a processor; and
memory including instructions, which when executed by the processor, perform a method comprising:
obtaining an input query;
in response to the input query:
generating a token sequence associated with the input query by applying a beam search algorithm on generated bound knowledge graphs;
applying the input query to a large language model (LLM) to obtain first outputs;
applying the generated token sequence to a graph neural network (GNN) to obtain second outputs;
applying fusion layers on the first outputs and the second outputs to generate a response associated with the input query and generated token sequence; and
performing a remediation using the generated response, wherein the remediation comprises updating the LLM and the GNN based on the generated response.

16. The system of claim 15, further comprising:
prior to obtaining the input query:
obtaining a data source associated with the LLM;
applying one or more learned node queries and the data source to an encoder-decoder language model to obtain node features;
applying a permutation matrix on the node features using a prediction head module to obtain generated nodes;
generating node edges using a second prediction head module; and
applying a preferential attachment module on the generated nodes and the generated node edges to generate a bound knowledge graph of the generated bound knowledge graphs.

17. The system of claim 16, wherein the beam search algorithm comprises determining a sequence of the generated nodes based on situational constraints and the node features.

18. The system of claim 16, wherein the data source is a tabular dataset associated with order-to-cash information, wherein the input query comprises question in a natural language asking for information corresponding to the tabular dataset, and wherein the generated response is in the natural language.

19. The system of claim 16, wherein the data source is a conversation between a user of a client environment via a client device and an administrator of the client environment.

20. The system of claim 15, wherein the generated response is based on a set of response templates associated with the LLM.
